(19) United States
(12) Patent Application Publication
(10) Pub. No.: US 2022/0121069 A1
(43) Pub. Date: Apr. 21, 2022

(54) DISPLAY DEVICE

(71) Applicant: TCL CHINA STAR OPTOELECTRONICS TECHNOLOGY CO., LTD., Shenzhen (CN)

(72) Inventors: Huanhsun TUNG, Shenzhen (CN); Qiusheng HUANG, Shenzhen (CN)

(73) Assignee: TCL CHINA STAR OPTOELECTRONICS TECHNOLOGY CO., LTD., Shenzhen (CN)

(21) Appl. No.: 16/767,244

(22) PCT Filed: Apr. 14, 2020
(86) PCT No.: PCT/CN2020/084638

§ 371 Date: May 27, 2020

(30) Foreign Application Priority Data
Mar. 30, 2020 (CN) 202010237813.8

(51) Int. Cl. G02F 1/1343; G02F 1/1335

(52) U.S. Cl. CPC G02F 1/134345; G02F 1/133531

(57) ABSTRACT

The present disclosure provides a display device, including a first display panel and a second display panel disposed on the first display panel. The first display panel includes a plurality of display units configured to display black images, white images, or gray images. The second display panel includes a plurality of pixel units configured to display color images. Each of the display units corresponds to some of the pixel units.

### FIELD OF INVENTION

The present disclosure relates to the field of display technologies, and particularly relates to a display device.

### BACKGROUND OF INVENTION

Liquid crystal display devices are display devices that use liquid crystal compositions for display, and a typical display method thereof is: backlight source irradiates light to a liquid crystal display device in which a liquid crystal composition is enclosed between a pair of substrates, and the liquid crystal composition is applied with a voltage to change orientations of liquid crystal molecules, thereby controlling an amount of light transmitted through the liquid crystal display device. Such liquid crystal display device has advantages of thinness, light weight, and low power consumption. Therefore, the liquid crystal display device can be used in electronic devices such as smart phones, tablet PCs, and car navigation systems.

In prior art, single-layer liquid crystal display devices have relatively low contrast and cannot occupy an advantage in competition with OLED display devices.

However, in double-layer liquid crystal display devices, due to a stacked display of double-layer liquid crystal pixels, a problem of reduction in transmittance caused thereby needs to be solved urgently.

### Technical Problems

The present disclosure provides a display device to solve the technical problem of reduction in transmittance caused by the stacked display of double-layer liquid crystal pixels.

### Technical Solutions

The present disclosure provides a display device including: a first display panel including a plurality of display units configured to display black images, white images, or gray images; a second display panel disposed on the first display panel and including a plurality of pixel units configured to display color images. Wherein each of the plurality of display units corresponds to some of the plurality of pixel units.

Furthermore, the display device further includes a backlight module disposed on a side of the first display panel away the second display panel.

Furthermore, each of the plurality of pixel units includes a plurality of second subpixels, the plurality of subpixels comprises blue subpixels, green subpixels, and red subpixels, and each of the plurality of pixel units comprises three types of subpixels arranged horizontally.

Furthermore, in a column direction, colors of the subpixels in a same column remain same; and in a row direction, colors of two adjacent subpixels are different.

Furthermore, in a same direction, a dimension of each of the pixel units is less than a dimension of each of the display units.

Furthermore, each of the pixel units and each of the display units have a same shape, and a dimension ratio of each of the pixel units and each of the display units in a same direction is 2:1.

Furthermore, each of the pixel units and each of the display units have a same shape, and a dimension ratio of each of the pixel units and each of the display units in a same direction is 3:1.

Furthermore, each of the pixel units and each of the display units have a same shape, and a dimension ratio of each of the pixel units and each of the display units in a same direction is 4:1.

Furthermore, each of the display units includes: a first polarizer disposed on a side of a backlight module; a first glass substrate disposed on a side of the first polarizer away from the backlight module; a first liquid crystal layer disposed on a side of the first glass substrate away from the first polarizer; a second glass substrate disposed on a side of the first liquid crystal layer away from the first liquid crystal layer; and a first analyzer disposed on a side of the second glass substrate away from the first liquid crystal layer; the pixel unit includes: a second polarizer disposed on a side of the first analyzer away from the second glass substrate; a third glass substrate disposed on a side of the second polarizer away from the first analyzer; a second liquid crystal layer disposed on a side of the third glass substrate away from the second polarizer; the subpixels being disposed on a side of the second liquid crystal layer away from the third glass substrate; a fourth glass substrate disposed on a side of the subpixels away from the second liquid crystal layer; and a second analyzer disposed on a side of the fourth glass substrate away from the subpixels.

Furthermore, a transmission axis of the first polarizer and a transmission axis of the first analyzer are perpendicular to each other; the transmission axis of the first analyzer and a transmission axis of the second polarizer are parallel to each other; and the transmission axis of the second polarizer and a transmission axis of the second analyzer are perpendicular to each other.

### Beneficial Effects

In the display device of the present disclosure, a first display panel and a second display panel are stacked to improve color brightness of the display device. The first display panel uses a liquid crystal layer without color resist, so each of the display units is a complete unit, thereby improving penetration rate of the first display panel. According to various resolutions of the first display panel, each of the display units corresponds to a different number of pixel units. The higher the resolution of the first display panel, the higher the contrast of the display device, and the higher the display quality; the lower the resolution of the first display panel, the lower the manufacturing cost of the display device. Furthermore, a resolution of the second display panel is not changed, the resolution of the display device will not be affected by reduction in the resolution of the first display panel.

### DESCRIPTION OF DRAWINGS

Following describes specific implementations of the present disclosure in detail with reference to accompanying drawings, which will make the technical solutions and other beneficial effects of the present disclosure obvious.

FIG. 1 is a schematic view of a display device according to an embodiment.

FIG. 2 is a schematic view of a first display panel according to an embodiment.

FIG. 3 is a schematic view of a second display panel according to an embodiment.

FIG. 4 shows a correspondence diagram of pixel units and a display unit according to an embodiment.

In the figures:
10 display device;
110 first display panel; 120 second display panel;
130 backlight module; 111 display unit;
11101 first polarizer; 11102 first glass substrate;
11103 first liquid crystal layer; 11104 second glass substrate;
11105 first analyzer; 121 pixel unit;
12101 second polarizer; 12102 third glass substrate;
12103 second liquid crystal layer; 12104 subpixel;
12105 fourth glass substrate; 12106 second analyzer.

### DETAILED DESCRIPTION OF EMBODIMENTS

The technical solutions in the embodiments of the present disclosure will be clearly and completely described with reference to the accompanying drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative work fall into protection scope of the present disclosure.

In the present disclosure, unless specifically stated and defined otherwise, that a first feature is “on” or “under” a second feature may include: the first feature and the second feature are not in direct contact but are contacted by another feature between them. Furthermore, that the first feature is “on”, “above”, or “upon” the second feature includes that the first feature is directly above and obliquely above the second feature, or merely indicates that the first feature is higher in level than the second feature. That the first feature is “under” or “below” the second feature includes that the first feature is directly below and obliquely below the second feature, or merely indicates that the first feature is lower in level than the second feature.

Following disclosure provides various different implementations or examples for implementing different structures of the present disclosure. To simplify the disclosure of the present disclosure, components and settings of specific examples are described below. Of course, they are merely examples and are not intended to limit the present disclosure. In addition, the present disclosure may repeat reference numbers and/or reference letters in different examples, and such repetition is for purpose of simplicity and clarity, and does not indicate relationship between the various embodiments and/or settings discussed. In addition, examples of various specific processes and materials are provided in the present disclosure, but those of ordinary skill in the art may be aware of application of other processes and/or other materials.

### Embodiment

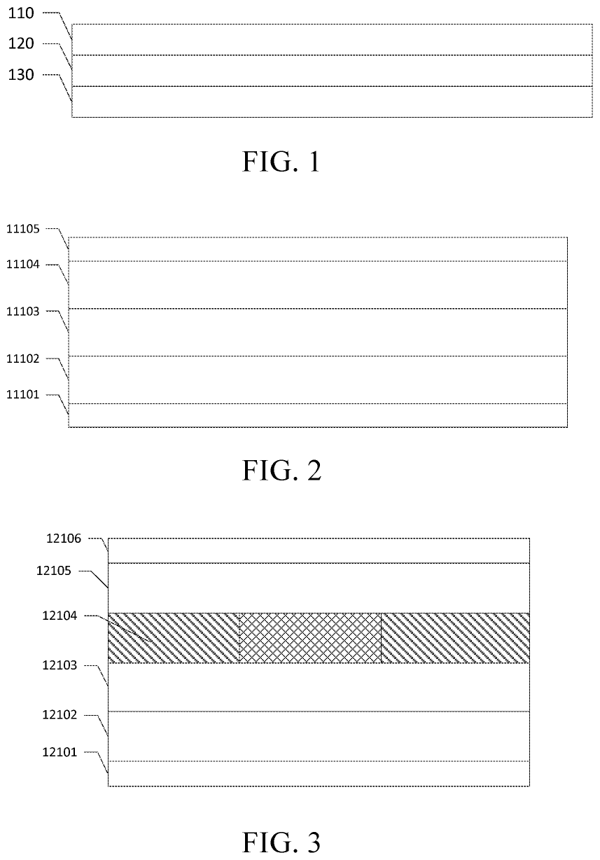

As shown in FIG. 1, in this embodiment, the display device 10 includes a first display panel 110, a second display panel 120, and a backlight module 130.

The display device 10 has double display panels. Wherein, the first display panel 110 does not include RGB color resists, and merely displays black images, white images, or gray images. The first display panel 110 is mainly used to adjust a backlight brightness of the display device 10, thereby effectively improving display quality of the display device 10.

As shown in FIG. 2, specifically, the first display panel 110 includes a plurality of display units 111. Each of the plurality of display units 111 includes a first polarizer 11101, a first glass substrate 11102, a first liquid crystal layer 11103, a second glass substrate 11104, and a first analyzer 11105.

The first polarizer 11101 is disposed on a side of the backlight module 130. The first polarizer 11101 can absorb light parallel to its arrangement direction and merely transmit light in a direction perpendicular to its arrangement direction.

The first glass substrate 11102 is disposed on a side of the first polarizer 11101 away from the backlight module 130. The first glass substrate 11102 is a transparent glass substrate, so as to let light emitted from the first polarizer 11101 directly enter the first liquid crystal layer 11103. That is, the first glass substrate 11102 achieves a purpose of carrying the first liquid crystal layer 11103 and does not affect light extraction efficiency of the display unit 111.

The first liquid crystal layer 11103 is disposed on a side of the first glass substrate 11102 away from the first polarizer 11101. A direction of passable light emitted from the first analyzer 11105 is perpendicular to a direction of passable light emitted from the first polarizer 11101. When there is no electric field above or below the first liquid crystal layer 11103, liquid crystal molecules in the first liquid crystal layer 11103 are parallel to the arrangement direction of the first polarizer 11101, light emitted from the first liquid crystal layer 11103 cannot pass through the first analyzer 11105, and the display unit does not display images.

When electric fields are applied above and below the first liquid crystal layer 11103, the liquid crystal molecules in the first liquid crystal layer 11103 are perpendicular to the arrangement direction of the first polarizer 11101, that is, a direction of light emitted from the first liquid crystal layer 11103 is parallel to the direction of the passable light emitted from the first analyzer 11105, and the display unit displays white light at this time.

Conversion speeds and twist angles of the liquid crystal molecules are determined by voltages applied to the first liquid crystal layer 11103. Therefore, the display unit 111 can display all black images, all white images, or gray images between all black and all white.

The second display panel 120 is a color pixel layer, which can make the display device 10 display color images.

As shown in FIG. 3, specifically, the second display panel 120 includes a plurality of pixel units 121. Each of the pixel units 121 includes a second polarizer 12101, a third glass substrate 12102, a second liquid crystal layer 12103, subpixels 12104, a fourth glass substrate 12105, and a second analyzer 12106.

The second polarizer 12101 is disposed on a side of the first analyzer 11105 away from the second glass substrate 11104. In order to ensure that light emitted from the first display panel 110 can maximumly enter the second display panel 120, a direction of passable light emitted from the second polarizer 12101 is the same as the direction of the passable light emitted from the first analyzer 11105.

The third glass substrate 12102 is disposed on a side of the second polarizer 12101 away from the first analyzer 11105. A material of the third glass substrate 12102 is the same as material of the first glass substrate 11102.

The second liquid crystal layer 12103 is disposed on a side of the third glass substrate 12102 away from the second polarizer 12101. The direction of the passable light emitted from the second polarizer 12101 is perpendicular to a direction of passable light emitted from the second analyzer 12106. When there is no electric field above or below the second liquid crystal layer 12103, liquid crystal molecules in the second liquid crystal layer 12103 are parallel to an arrangement direction of the second polarizer 12101, light emitted from the second liquid crystal layer 12103 cannot pass through the second analyzer 12106, and the display unit does not display images.

The subpixels 12104 are disposed on a side of the second liquid crystal layer 12103 away from the third glass substrate 12102. The subpixels 12104 include three colors: blue subpixels, green subpixels, and red subpixels. In this embodiment, each of the pixel units 121 includes three types of subpixels 12104 arranged horizontally. Since the pixel unit 121 includes constituent pixels of three primary colors, each of the pixel units 121 can display images of any color composed of the three primary colors.

When electric fields are applied above and below the second liquid crystal layer 12103, the liquid crystal molecules in the second liquid crystal layer 12103 are perpendicular to the arrangement direction of the second polarizer 12101, that is, a direction of light emitted from the second liquid crystal layer 12103 is parallel to the direction of the passable light emitted from the second analyzer 12106, and due to presence of subpixels, the second display panel 120 can display color images.

Brightness and color contrast of the display device 10 can be controlled by adjusting voltages applied to the first display panel 110 and the second display panel 120, thereby improving display quality of the display device 10.

The first display panel 110 of the embodiment does not provide a pixel layer, so that the first display panel 110 merely displays black images, white images, and gray images. On one hand, this design saves manufacturing costs of the display device 10, on the other hand, this design improves penetration rate of the first display panel 110. When the resolution of the first display panel 110 is 1920*1080, the transmittance of the first display panel 110 may be increased by 108%, and when the resolution of the first display panel 110 is 1280*720 or 960*540, the transmittance of the first display panel 110 can be increased by 105%.

In this embodiment, the display device 10 is a 4K display device, and its resolution is mainly determined by the second display panel 120, and a resolution of the second display panel 120 is 3840*2160.

In order to save manufacturing costs, the resolution of the first display panel 110 is generally less than the resolution of the second display panel 120. In this embodiment, the resolution of the first display panel 110 is 1920*1080, 1280*720, or 960*540.

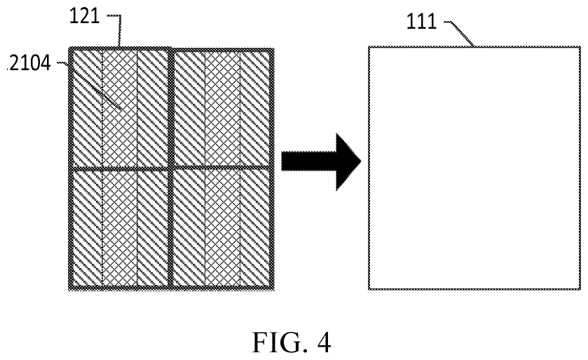

As shown in FIG. 4, when the resolution of the first display panel 110 is 1920*1080, one of the display units 111 can “accommodate” four pixel units 121.

When the resolution of the first display panel 110 is 1280*720, one of the display units 111 can “accommodate” nine pixel units 121.

When the resolution of the first display panel 110 is 960*540, one of the display units 111 can “accommodate” sixteen pixel units 121.

The higher the resolution of the first display panel 110, the better the color brightness of the display device 10, but the lower the resolution of the first display panel 110, the lower the preparation costs.

The descriptions of the above embodiments is merely used to help understand the technical solution of the present disclosure and its core ideas; it will be understood by those of ordinary skill in the art that the technical solutions described in the foregoing embodiments may be modified or equivalently substituted for some or all of the technical features, and the modifications or substitutions do not depart from the scope of the technical solutions of the embodiments of the present disclosure.

1. A display device, comprising:
a first display panel comprising a plurality of display units configured to display black images, white images, or gray images;
a second display panel disposed on the first display panel and comprising a plurality of pixel units configured to display color images, wherein each of the plurality of display units corresponds to some of the plurality of pixel units.

2. The display device in claim 1, further comprising:
a backlight module disposed on a side of the first display panel away the second display panel.

3. The display device in claim 1, wherein
each of the plurality of pixel units comprises a plurality of subpixels, the plurality of subpixels comprise blue subpixels, green subpixels, and red subpixels, and each of the plurality of pixel units comprises three types of subpixels arranged horizontally.

4. The display device in claim 3, wherein
in a column direction, colors of the subpixels in a same column remain same; and
in a row direction, colors of two adjacent subpixels are different.

5. The display device in claim 1, wherein
in a same direction, a dimension of each of the pixel units is less than a dimension of each of the display units.

6. The display device in claim 4, wherein
each of the pixel units and each of the display units have a same shape, and a dimension ratio of each of the pixel units and each of the display units in a same direction is 2:1.

7. The display device in claim 4, wherein
each of the pixel units and each of the display units have a same shape, and a dimension ratio of each of the pixel units and each of the display units in a same direction is 3:1.

8. The display device in claim 4, wherein
each of the pixel units and each of the display units have a same shape, and a dimension ratio of each of the pixel units and each of the display units in a same direction is 4:1.

9. The display device in claim 1, wherein
each of the display units comprises:
a first polarizer disposed on a side of a backlight module;
a first glass substrate disposed on a side of the first polarizer away from the backlight module;
a first liquid crystal layer disposed on a side of the first glass substrate away from the first polarizer;
a second glass substrate disposed on a side of the first liquid crystal layer away from the first glass substrate; and
a first analyzer disposed on a side of the second glass substrate away from the first liquid crystal layer; and
wherein each of the pixel units comprises:
a second polarizer disposed on a side of the first analyzer away from the second glass substrate;
a third glass substrate disposed on a side of the second polarizer away from the first analyzer;
a second liquid crystal layer disposed on a side of the third glass substrate away from the second polarizer;
the subpixels being disposed on a side of the second liquid crystal layer away from the third glass substrate;
a fourth glass substrate disposed on a side of the subpixels away from the second liquid crystal layer; and
a second analyzer disposed on a side of the fourth glass substrate away from the subpixels.

10. The display device in claim 9, wherein
a transmission axis of the first polarizer and a transmission axis of the first analyzer are perpendicular to each other;
the transmission axis of the first analyzer and a transmission axis of the second polarizer are parallel to each other; and
the transmission axis of the second polarizer and a transmission axis of the second analyzer are perpendicular to each other.
